(19) United States
(12) Patent Application Publication
(10) Pub. No.: US 2002/0084648 A1
(43) Pub. Date: Jul. 4, 2002

(54) Accurate registration for imaging

(76) Inventors: Robert Pierce, Williamsville, NY (US); Anthony Moscato, North Tonawanda, NY (US)

Correspondence Address: NIXON & VANDERHYE P.C., 8th Floor, 1100 North Glebe Rd., Arlington, VA, 22201-4714, US

(21) Appl. No.: 09/749,760

(22) Filed: Dec. 28, 2000

(51) Int. Cl. B32B 3/00; B42D 15/00; B32B 27/14; B42D 15/10

(52) U.S. Cl. 283/72; 428/195

(57) ABSTRACT

Images, particularly colored images, are precisely registered with respect to each other when printed at spaced locations in the direction of movement of a web or sheet. Invisible sense marks are provided at spaced locations along the direction of movement and are opto-electronically sensed at each location where an imaging device is provided. The sense marks may be provided so as to define a rule to provide substantially an absolute measure of the position of the web or sheet. The sense marks may be spaced from each other about 0.01 inches or less, e.g. about one pixel.

### BACKGROUND AND SUMMARY OF THE INVENTION

The invention relates to a method and system for precisely registering images printed at different locations along the dimension of elongation (or movement) of a web, or sheet. The invention also relates to a web or sheet having particular sense marks thereon for facilitating accurate registration well (though not exclusively) suited for four color printing.

In printing a moving web of material (paper, plastic, cloth, etc.) it is often necessary to perform operations on the web in sequence where a subsequent operation has to be registered with a previous operation. Typically this occurs when printing multiple colors. The elements of the color (cyan, magenta, yellow) are printed at different times on a moving web, yet to obtain the correct colors and quality, each color must be accurately registered to the others. Another example of accurate registration being required is when electronically printing data onto a pre-printed form. The electronic printing ((such as ink jet printing, laser printing, etc.) must be imaged in the correct position with respect to the background (or pre-print).

One conventional way of achieving registration between two colors of printing on a continuous web is to pre-print, usually, but not necessarily, with by a conventional printing method (lithography, flexo, etc.) a “sensemark” on the web. Such a sensemark is usually a black mark about ½″ wide (across-the-web) and ⅛″ to ¼″ long (along the web). An opto-electronic sensor then signals when the sensemark passes and triggers a signal for the electronic printer to print. Incorporated into the logic of this conventional system are suitable delays to account for time lags in the passage of the web to the correct position for printing, the time to start printing and so on. Such timing and measurement of distances on the web is made by an encoder which provides a series of pulses proportional to the distance the web travels. The drawback of this process is that, although fairly accurate on average over long distances on the web, it is not sensitive to short term (microsecond/inches on the web) fluctuations in the position of the web. Such fluctuations may be caused by variations in web tension caused by out-of-round rollers, web cut-offs and the like, or by the manufacturing inaccuracies in individual rollers, or by worn bearings, by substrate elasticity variations, substrate dimensional changes after a first color application, and by the distance between color applications. Also, while individual inaccuracies may be negligible, the accumulations will render very accurate registration difficult.

Thus while the encoder and sense mark detection devices provide good, average measurement of position, within a form (typically, 3″ to 33″ long) fluctuations in web speed and tension create inaccuracies.

These inaccuracies are important when electronically printing different primary colors of a digital color image. The printheads may be separated by distances ranging from a few inches to a few feet, yet the individual images from these printheads must be registered to within less than one pixel (typically between about 0.001″ to 0.004″).

To achieve this registration accuracy, a continuous measurement of distance which can respond to short term fluctuations is required. This is achieved according to the invention by continuously printing a series of marks on the web which can be read optically at a position adjacent to the printing device and which control the timing of the printing of said device so that, in effect, they form multiple sense marks on encoder marks so that short term fluctuations in web position are accounted for and the registration is very accurate.

In a simple case, such series of registration marks may be black bars of equal thickness, one or several pixels wide, separated by unprinted bars, one or several pixels wide, printed continuously on the web. Since such a pattern would be visually intrusive and/or take up “real estate” on the web, it is desirable that such marks be printed using invisible ink which can be detected in the IR or UV part of the electromagnetic spectrum. Such inks can be printed over pre-prints or may, in turn, be over-printed with electronic printing.

Furthermore, such marks may be electronically printed themselves. For example, an ink jet printhead may image a series of marks in an invisible ink. Subsequently, further down the web, ink jet printers will print cyan, magenta, yellow and black to create a process color image. Associated with each of the color printers is a sensor which reads the invisible marks and provides the correctly timed signal to enable the printing.

The invisible sense marks/encoder marks may be printed in such a way as to provide absolute measure of the position of the web, rather than just a relative position. For example, on an 11″ form the invisible sensmarks/encoder marks would form an accurate rule, readable opto-electronically from 0 to 11″ in increments of 0.001″.

According to one aspect of the invention there is provided a method of accurately registering and imaging a web or sheet comprising: (a) Imaging a plurality of sense marks invisible to a naked human eye along the web or sheet, spaced from each other in a first direction. (b) Moving the web or sheet substantially in the first direction. Then during the practice of (b): (c) Imaging different colors on the web or sheet at at least first and separate locations spaced from each other in the first direction. (d) Sensing the sense marks at both the first and second separate locations. And (e) in response to (d), controlling (c) so that the different colors are imaged in precise registry with each other. For example, (a) is practiced so that a plurality of sense marks are spaced from each other in the first direction about 0.01 inches or less.

In a preferred embodiment of the invention (c) and (d) are practiced at four separate locations so that cyan, magenta, yellow and black are printed, one at each location, and (e) is practiced so as to precisely register at least two of the cyan, magenta, and yellow on top of each other at at least some portions of the web or sheet.

Further, (a) may be practiced to provide a rule along the sheet, or at repeat locations along the web, to provide substantially an absolute measure of the position of the web or sheet. Also, (a) may be practiced using IR or UV ink, (e) may be practiced by ink jet printing, and (d) is preferably practiced opto-electronically. Also, (a) may be practiced to image the same marks so that they are about one pixel wide and spaced from each other about one pixel; and typically (a)-(e) are practiced so that the colors are imaged so that they are registered with an accuracy of one pixel or less. Also (a) may be practiced to provide the sense marks in a repeating pattern so that the method is tolerant of registration changes larger than the distance between sense marks in the first direction.

According to another aspect of the invention there is provided a method of accurately registering and imaging a web or sheet comprising: (a) Imaging a plurality of sense marks in the web or sheet spaced from each other in a first direction to provide a rule along the sheet, or at repeat locations along the web, to provide substantially an absolute measure of the reposition of the web or sheet. (b) Moving the web or sheet substantially in the first direction. Then during the practice of (b): (c) Sensing the sense marks at a plurality of locations spaced from each other in the first direction. And (d) in response to (c), at each of the sensed locations imaging the web or sheet so that the images applied at the plurality of spaced locations are precisely aligned with each other. According to this aspect (d) may be practiced to image a different color at each of at least three different spaced locations.

According to another aspect of the invention there is a web or sheet imaging system comprising: A web or sheet having a plurality of sense marks thereon spaced from each other in a first direction. A plurality of sensing and imaging stations spaced from each other in the first direction, each station having a sensor for sensing the sense marks, and an imaging device which images a different color on the web or sheet than at the other of the sensing and imaging stations. Means for moving the web or sheet substantially in the first direction past the spaced sensing and imaging stations. And a controller which controls each of the imaging devices in response to its associated sensor to precisely image the web or sheet. Preferably the sense marks are provided in a repeating pattern so that the system is tolerant of registration changes larger than the distance between sense marks in the first direction.

The invention also comprises a web or sheet (substrate) elongated in a dimension of elongation, and comprising a plurality of sense marks that are capable of being opto-electronically sensed and are invisible to the naked human eye, the sense marks being provided as a rule along the sheet, or at repeat locations along the direction of elongation of the web, to provide substantially an absolute measure of the position of the web or sheet. The sense marks are spaced from each other along the direction of elongation of the web or sheet a distance of about 0.01 inches or less.

It is the primary object of the present invention to provide for the accurate and effective registry of images on a substrate (web or sheet). This and other objects of the invention will be clear from the following drawings and claims.

### BRIEF DESCRIPTION OF THE DRAWINGS

FIG. 1 is a schematic block diagram showing the practice of exemplary procedures in a method according to the present invention;

FIGS. 2A-2C are schematic views showing various stages of the imaging of a web according to the invention;

FIG. 3 is a schematic view of an exemplary system according to the invention;

FIG. 4 is a schematic top view of an exemplary sheet with sense marks according to one embodiment of the invention; and

FIG. 5 is a schematic partial top view of an exemplary web according to an embodiment of the invention.

### DETAILED DESCRIPTION OF THE DRAWINGS

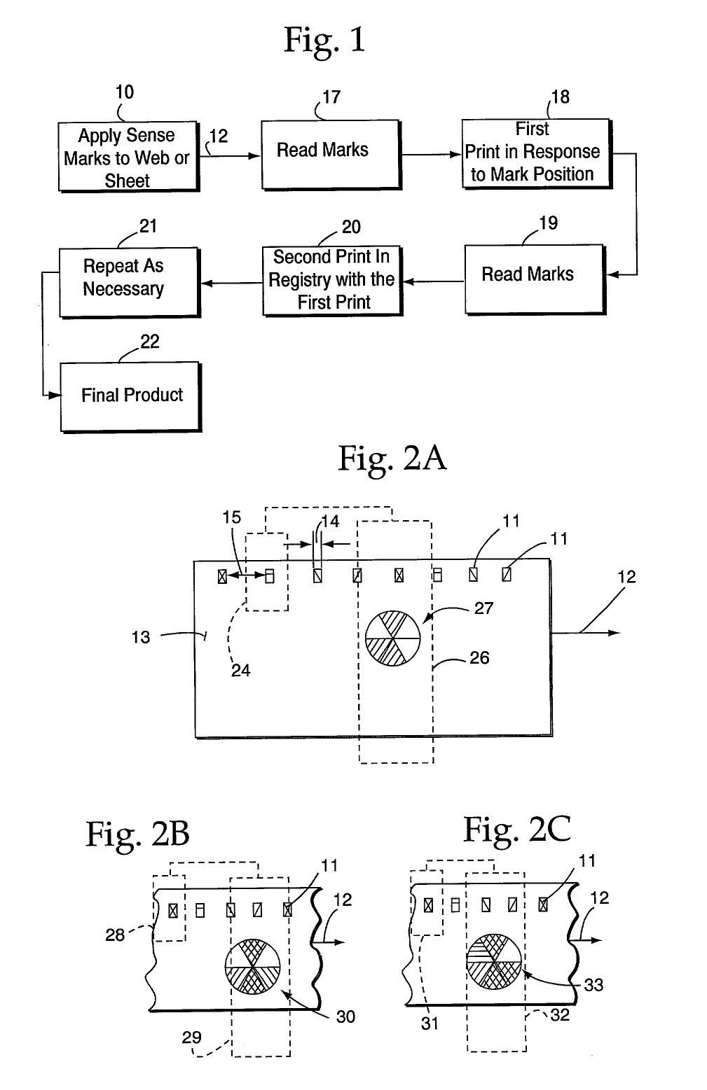

FIG. 1 illustrates in block form one embodiment of an exemplary method according to the present invention. Firstly, as indicated by box 10, sense marks are applied to a substrate (sheet or web) of flexible imagable material such as paper, many plastics, cardboard, paperboard, etc. The sense marks may be magnetic or have other properties than can bed electronically sensed by an appropriate sensor, but preferably are capable of being optically sensed. The marks may be applied using any suitable imaging technique such as flexographic printing, ink jet printing, or laser printing. While visible ink may be used, it is preferred that the ink be invisible to the naked human eye, such as UV or IR inks, which may be sensed by ultraviolet or infrared sensors, respectively. The sense marks, which are shown only schematically for one embodiment thereof at 11 in FIG. 2A, are spaced from each other in a first direction 12, which is also substantially the direction of movement of the substrate 13.

While the dimensions of the marks 11 in the direction 12 may vary widely depending upon the particular circumstances, preferably the dimension 14 (see FIG. 2A) is about 0.01 inches [0.25 mm] or less, preferably one, or several pixels, a pixel typically being between about 0.001-0.004 inches. Also, the spacing 15 (see FIG. 2A) between sense marks is also preferably about 0.01 inches or less, e.g. one or several pixels. The marks 11 may be of all the same type and size and spacing, or somewhat different types (as schematically illustrated in FIG. 2A, four different types being shown), and sizes, and spacings. The marks 11 are preferably provided in a substantially straight line configuration, as seen in FIG. 2A, or may be staggered (FIG. 5).

After the sense marks are applied at 10 they are sensed at a first location, as indicated by box 17 in FIG. 1, as the substrate moves (powered by conventional apparatus) in direction 12. In response to sensing at 17 a first, geometrically proximate, printing occurs at 18. The procedures 17, 18 are repeated, as indicated at 19 and 20, respectively, at least a second time, and preferably for all of cyan, magenta, yellow and black, as schematically indicated at 21 in FIG. 1. The final product is produced at 22 using as conventional finishing operations, such as —especially for business form production —bursting, slitting, laminating, cutting into sheets, further imaging or coating, etc.

FIGS. 2A-2C schematically show on exemplary (only) method that can be practiced according to the invention. A conventional optical sensor 24 (FIG. 2A) senses one or more marks 11 at a location proximate (typically no more than a few inches away from) a printer 26, such as an ink jet printer, for imaging a first ink color such as cyan, in a predetermined pattern 27. Then at a spaced location in direction 12 (the path of the substrate 13 may take various turns) a second sensor 28 senses one or more marks 11 and causes the second color printer 29 to print a second color (e.g. magenta) in registry with the first pattern 27, as indicated schematically at 30 in FIG. 2B including where some magenta has been printed over some cyan to produce some purple color. Then at a third location (FIG. 2C) a third sensor 31 and third color printer 32 are provided which print a third color, e.g. yellow, including perhaps some over cyan and/or magenta to produce green, orange, or another color. This may be generally repeated at a black ink station downstream of the station of FIG. 2C in the direction 12.

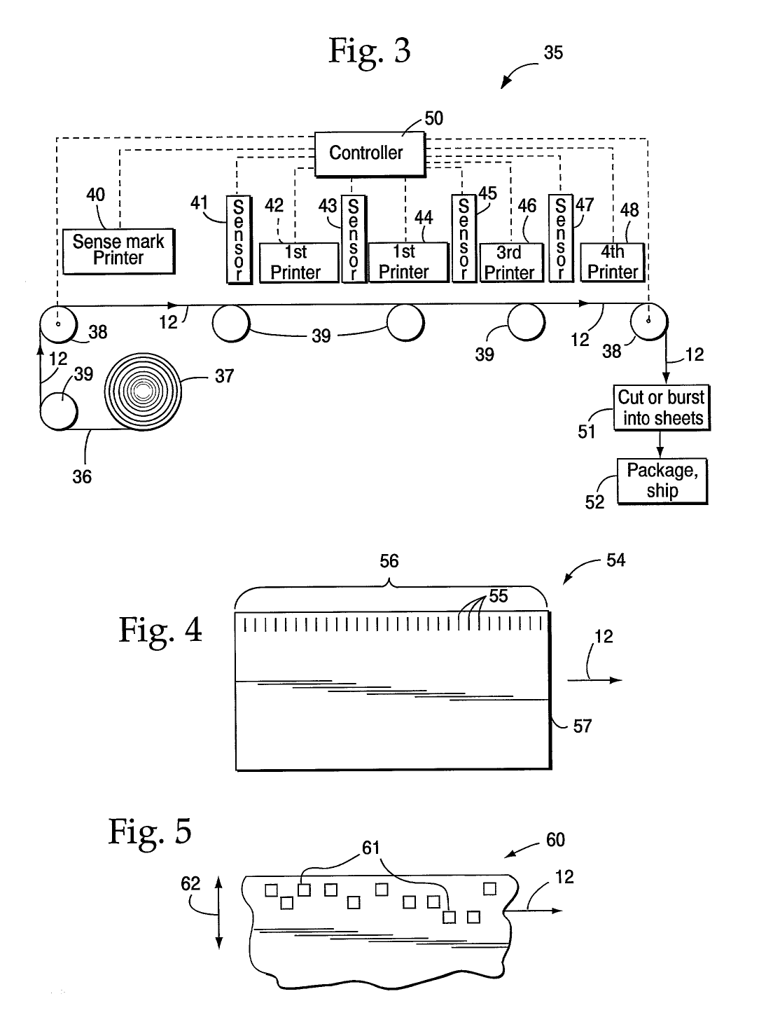

FIG. 3 schematically illustrates an exemplary system 35 for practicing the method described above, for processing of a web 36. The web 36 may be unwound from a roll 37 and fed/moved by any conventional means, such as powered rollers 38 and idler rollers 39, past an imaging device 40 (such as an ink jet printer) to print preferably invisible sense marks (11) on the web 36. Then the web 36 moves in direction 12 past the conventional optical sensor, conventional imaging device (e.g. printer), sets 41, 42; 43, 44; 45,46; and 47,48, where various colored images are printed on the web 36 with a high degree of positional accuracy, so that the sense marks (11) are in a repeating pattern so that the system 35 is tolerant of registration changes between sense marks in direction 12. This allows one color to be registered with respect to another within an accuracy of one pixel or less even though there may be web tension, web elasticity, or web dimensional, variations or changes.

A conventional controller 50 may synchronously control all of the elements 40-48, as well as web speed. Controller 50 receives input from an operating program advising what images are to be printed where, input from the sensors 41, 43, 45, 47, and various other inputs, such as web 36 speed, and controls the conventional printers 42, 44, 46, 48 (e.g. ink jet, flexographic, laser, etc.) to get the desired final imaged product (e.g. magazine, mail insert, business form, etc.)

After printing the web 36 can be rolled up, or cut or burst into sheets, as indicated by 51 in FIG. 3, and packaged, shipped, and/or otherwise processed as indicated at 52.

FIG. 4 shows a sheet form of substrate 54 according to the invention having sense marks 55 (shown as visible but preferably invisible to the naked human eye) which define a rule 56 along the dimension of elongation (in direction 12) of the sheet 54. That is the marks 55 are uniformly spaced apart, and frequently, e.g. every inch or less, preferably every 0.01 inches or less, e.g., are even provided every other pixel. The repeat locations of marks 55 provide substantially an absolute measure of the position of the sheet 54 when moving in direction 12, the number of marks 53 from the leading edge 57 thereof (which can be sensed per se, or have a special mark that is easily sensed) tells the exact location of that portion of sheet 54. This same technique can be used for webs, repeating the rule 56 every form or page length (e.g. every eleven inches).

FIG. 5 shows an embodiment where the substrate is a web 60, and the sense marks 61 are provided in rows that are staggered, i.e. spaced in the width dimension 62 of the web 60 (e.g. substantially perpendicular to direction 12).

Thus, it will be seen that the invention provides advantageous methods, systems, and substrates, overcoming problems inherent in the prior art.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of accurately registering and imaging a web or sheet comprising:
(a) imaging a plurality of sense marks invisible to a naked human eye along the web or sheet, spaced from each other in a first direction;
(b) moving the web or sheet substantially in the first direction; then during the practice of (b)
(c) imaging different colors on the web or sheet at at least first and separate locations spaced from each other in the first direction;
(d) sensing the sense marks at both the first and second separate locations; and
(e) in response to (d), controlling (c) so that the different colors are imaged in precise registry with each other.

2. A method as recited in claim 1 wherein (a) is practiced so that a plurality of sense marks are spaced from each other in the first direction about 0.01 inches or less.

3. A method as recited in claim 1 wherein (c) and (d) are practiced at four separate locations so that cyan, magenta, yellow and black are printed, one at each location; and wherein (e) is practiced so as to precisely register at least two of the cyan, magenta, and yellow on top of each other at at least some portions of the web or sheet.

4. A method as recited in claim 2 wherein (a) is practiced to provide a rule along the sheet, or at repeat locations along the web, to provide substantially an absolute measure of the position of the web or sheet.

5. A method as recited in claim 3 wherein (c) is practiced by ink jet printing.

6. A method as recited in claim 3 wherein (d) is practiced opto-electronically.

7. A method as recited in claim 3 wherein (a) is practiced using IR or UV ink.

8. A method as recited in claim 1 wherein (a) is practiced to image the sense marks so that they are about one pixel wide and spaced from each other about one pixel.

9. A method as recited in claim 1 wherein (a)-(e) are practiced so that the colors are imaged so that they are registered with an accuracy of one pixel or less.

10. A method as recited in claim 2 wherein (c) and (d) are practiced at four separate locations so that cyan, magenta, yellow and black are printed, one at each location; and wherein (e) is practiced so as to precisely register at least two of the cyan, magenta, and yellow on top of each other at at least some portions of the web or sheet.

11. A method of accurately registering and imaging a web or sheet comprising:
(a) imaging a plurality of sense marks in the web or sheet spaced from each other in a first direction to provide a rule along the sheet, or at repeat locations along the web, to provide substantially an absolute measure of the reposition of the web or sheet;
(b) moving the web or sheet substantially in the first direction; then during the practice of (b):
(c) sensing the sense marks at a plurality of locations spaced from each other in the first direction; and
(d) in response to (c), at each of the sensed locations imaging the web or sheet so that the images applied at the plurality of spaced locations are precisely aligned with each other.

12. A method as recited in claim 11 wherein (a) is practiced so that a plurality of sense marks are spaced from each other in the first direction about 0.01 inches or less.

13. A method as recited in claim 11 wherein (a) is practiced using IR or UV ink.

14. A method as recited in claim 12 wherein (c) is practiced opt-electronically.

15. A method as recited in claim 11 wherein (a) is practiced to image the sense marks so that they are about one pixel wide and spaced from each other about one pixel.

16. A method as recited in claim 11 wherein (d) is practiced to image a different color at each of at least three different spaced locations.

17. A method as recited in claim 11 wherein (a) is practiced to provide the sense marks in a repeating pattern so that the method is tolerant of registration changes larger than the distance between sense marks in the first direction.

18. A web or sheet imaging system comprising:
a web or sheet having a plurality of sense marks thereon spaced from each other in a first direction;
a plurality of sensing and imaging stations spaced from each other in the first direction, each station having a sensor for sensing said sense marks, and an imaging device which images a different color on said web or sheet than at the other of said sensing and imaging stations;
means for moving the web or sheet substantially in the first direction past said spaced sensing and imaging stations; and
a controller which controls each of said imaging devices in response to its associated sensor to precisely image the web or sheet.

19. A system as recited in claim 18 wherein said sense marks are provided in a repeating pattern so that said system is tolerant of registration changes larger than the distance between sense marks in the first direction.

20. A web or sheet elongated in a dimension of elongation, and comprising a plurality of sense marks that are capable of being opto-electronically sensed and are invisible to the naked human eye, said sense marks being provided as a rule along the sheet, or at repeat locations along the direction of elongation of the web, to provide substantially an absolute measure of the position of said web or sheet, said sense marks spaced from each other along the direction of elongation of said web or sheet a distance of about 0.01 inches or less.
